(19) United States
(12) Patent Application Publication
(10) Pub. No.: US 2016/0274658 A1
(43) Pub. Date: Sep. 22, 2016

(54) GRAPHIC METER DEVICE

(71) Applicant: YAZAKI CORPORATION, Minato-ku, Tokyo (JP)

(72) Inventor: Kazuyoshi Ogasawara, Shizuoka (JP)

(21) Appl. No.: 15/032,384

(22) PCT Filed: Dec. 2, 2014
(86) PCT No.: PCT/JP2014/081898

§ 371 Date: Apr. 27, 2016

(30) Foreign Application Priority Data
Dec. 2, 2013 (JP) 2013-249251

(51) Int. Cl. G06F 3/01; G01D 7/00; B60K 35/00

(52) U.S. Cl. CPC G06F 3/013; B60K 35/00; G01D 7/002; B60K 2350/2017; B60K 2350/2065; B60K 2350/962

(57) ABSTRACT

The display content of an instrument is automatically changed by detecting changes in a viewpoint position EP and a visual line direction DD. In a case of 2D drawing, the instrument is changed by combinations of enlargement, reduction, movement, and the like. In a case of 3D drawing, a stereoscopic image is rotated at its location. In a case of approach of a viewpoint, the stereoscopic image is returned to a standard state focusing on visibility. In a case of separation of the visual line, the stereoscopic image is rotated in a direction of going further away, and thus a stereoscopic effect is emphasized. Regarding an instrument matching a visual line direction, a stereoscopic image is directed toward the front side, and thus visibility is improved. In a case where the visual line direction is slightly deviated, the stereoscopic image is maintained in a state of being directed toward the front side, and, in a case where the visual line direction is greatly deviated, tracking control is gradually finished.

### TECHNICAL FIELD

The present invention relates to a display device which can be used as a meter unit displaying vehicular instruments, and particularly to a graphic meter device capable of performing graphical display.

### BACKGROUND ART

Regarding a meter unit or the like displaying vehicular instruments, in the related art, there are an analog meter displaying information such as a vehicle speed and an engine rotation speed by physically moving pointers, and a digital meter displaying information by displaying numerical values or text. In addition, there are cases where a bar graph is displayed instead of the pointer.

Further, in recent years, a liquid crystal display panel and the like which can display any of images, figures, characters, and the like through combination of a plurality of pixels, have been available at a relatively low cost. For this reason, it has been attempted to realize display of instruments or the like in the meter unit by using a variety of graphical displays.

In Patent Literature 1, vehicular meter units including a speedometer, a tachometer, and a submeter are realized through graphical display by using a screen of a liquid crystal display. In addition, each instrument such as a displayed speedometer is represented by an image in which a display state similar to a shape of an analog instrument having a pointer or a dial is created by using a three-dimensional computer graphics technique. Further, a position of a light source outside a vehicle is acquired, an incidence direction of external light which is incident to the screen of the liquid crystal display from the outside is calculated, a visual line direction of a driver is detected, and the incidence direction of the external light and the visual line direction are reflected in display content.

### CITATION LIST

### Patent Literature

[Patent Literature 1] JP-A-2010-58633

### SUMMARY OF INVENTION

### Technical Problem

In the technique disclosed in Patent Literature 1, in order to reproduce a natural shape equivalent to a stereoscopic real object instrument on a two-dimensional screen by using three-dimensional computer graphics, information regarding the incidence direction of the external light and the visual line direction of the driver is used. In other words, shadow generated by a three-dimensional shape of the real object instrument, gloss, reflected light from the instrument, and the like are computed in consideration of the incidence direction of the external light and the visual line direction of the driver, and visual information such as the shadow, the gloss, and the reflected light from the instrument is reproduced as display on the screen.

However, for example, in a general environment in which an automobile normally runs, a period of time in which an advancing direction of a vehicle is changed due to course changing is relatively short, and the vehicle travels substantially in a straight traveling state for the most of time during running. In addition, in a case where the vehicle travels in an environment such as wet weather, nighttime, or the inside of a tunnel, the vehicle is hardly influenced by external light such as sunlight.

Therefore, as in Patent Literature 1, even if shadow, gloss, reflected light from an instrument, or the like is reproduced in a natural state in consideration of an incidence direction of external light, the shadow, the gloss, the reflected light from the instrument, or the like does not change in a straight traveling state which occupies the most time during normal running. In other words, although the advanced three-dimensional computer graphics technique is employed, effective performance cannot be performed for a driver with such display, and a value suitable for the function of the device cannot be visually detected by the driver.

In addition, since a state occurs in which shadow, gloss, reflected light from an instrument, or the like cannot be displayed when the influence of external light is small as in an environment such as wet weather, nighttime, or the inside of a tunnel, effective performance cannot be performed and a shape of an instrument appears to be displayed in a flat manner, even in a case where the three-dimensional computer graphics is employed. Further, if the shadow, the gloss, reflected light from the instrument, or the like is displayed in an emphasized manner in an environment in which the actual influence of external light is small, the shadow, the gloss, reflected light from the instrument, or the like appears to be unnatural, and thus three-dimensional display lacking in reality is performed.

The present invention has been made in consideration of the above-mentioned circumstances, and an object thereof is to provide, to a driver, a graphic meter device capable of visually providing an advanced performance effect suitable for the actual installed display function.

### Solution to Problem

In order to achieve the above-mentioned object, the graphic meter device according to the present invention has the following features (1) to (6).

(1) A graphic meter device in which at least one instrument is drawn on a display screen, the device comprising:

a user detection part which detects one or both of a position of a viewpoint and a direction of a visual line in which the display screen is visually recognized; and

a display control part which controls a display state by changing the instrument drawn on the display screen corresponding to changes in the one or both of the position of the viewpoint and the direction of the visual line detected by the user detection part.

(2) The graphic meter device according to the above-mentioned (1),

wherein the display control part controls the display state by changing the instrument drawn on the display screen in one aspect or a plurality of aspects out of enlargement, reduction, and movement, which are combined.

(3) The graphic meter device according to the above-mentioned (1),

wherein the display control part controls the display state by changing the instrument drawn on the display screen in an aspect of rotation around a predetermined axis.

(4) The graphic meter device according to the above-mentioned (1),

wherein, in a case where the display control part recognizes a situation in which one of the instruments is located in the direction of the visual line detected by the user detection part, the display control part rotates the instrument so as to be a positional relationship in which the front side of the instrument is perpendicular to the direction of the visual line.

(5) The graphic meter device according to any one of the above-mentioned (1) to (4),

wherein, in a case where the display control part recognizes a situation in which the viewpoint detected by the user detection part comes close to the display screen, the display control part controls the display state by changing the instrument drawn on the display screen.

(6) The graphic meter device according to any one of the above-mentioned (1) to (4),

wherein, in a case where the display control part recognizes a situation in which the viewpoint detected by the user detection part goes away from the display screen, the display control part controls the display state by changing the instrument drawn on the display screen.

According to the graphic meter device with the configuration of the above (1), when a position of a viewpoint or a direction of a visual line of a user such as a driver changes, a display aspect of an instrument can be changed in response to the change. In other words, since special performance can be performed by automatically changing display content when the user's attitude or the like is changed, it is possible to visually provide a performance effect to the user.

According to the graphic meter device with the configuration of the above (2), since an enlargement, reduction or movement process is performed, in a case where three-dimensional display cannot be performed, or even in a case of design based on two-dimensional display, the graphical display element can be changed so as to be emphasized when viewed by the user.

According to the graphic meter device with the configuration of the above (3), since the display content is changed so that an instrument is rotated in a three-dimensional space, the user can visually detect stereoscopic display.

According to the graphic meter device with the configuration of the above (4), an instrument located in a visual line direction can be rotated and displayed so as to be automatically directed toward the front side of the user. In other words, in a situation in which the user watches a specific instrument, a direction of the instrument or the like can be directed toward the front side of the user so that visibility becomes best.

According to the graphic meter device with the configuration of the above (5), when the viewpoint is moved in a direction of coming close to the display screen, that is, in a situation in which there is a high probability that the user may visually recognize an instrument, a direction, the size, or the like of display can be automatically adjusted so that visibility becomes best.

According to the graphic meter device with the configuration of the above (6), when the viewpoint is moved in a direction of becoming distant from the display screen, that is, in a situation in which there is a high probability that a state in which the user visually recognizes an instrument may be finished, it is possible to cause an automatic change to a display state in which a performance effect is focused more than visibility.

### Advantageous Effects of Invention

According to the graphic meter device of the present invention, it is possible to visually provide an advanced performance effect suitable for the actual installed display function to a driver. In other words, since special performance can be performed by automatically changing display content when a user's attitude or the like is changed, it is possible to visually provide a performance effect to the user.

The above description relates to a brief description of the present invention. In addition, details of the present invention will become more apparent by reading through the mode of carrying out the invention (hereinafter, referred to as an “embodiment”) described below with reference to the drawings.

### BRIEF DESCRIPTION OF DRAWINGS

FIG. 1 is a front view illustrating an exterior of an entire display screen of a meter unit according to an embodiment.

FIG. 2 is a block diagram illustrating a configuration of an electrical circuit of the meter unit illustrated in FIG. 1.

FIG. 3 is a flowchart illustrating major contents controlled by the meter unit illustrated in FIG. 1.

FIG. 4 is a flowchart illustrating details of control corresponding to visual line direction change illustrated in FIG. 3.

FIG. 5 is a flowchart illustrating details of control corresponding to viewpoint position change illustrated in FIG. 3.

FIG. 6 is a front view illustrating a specific example of an image captured by an in-vehicle camera.

FIG. 7 is a schematic diagram illustrating a summary of a case where a screen of the meter unit is viewed from the top, and illustrates a specific example of display content state transition corresponding to changes in a viewpoint and a visual line.

### DESCRIPTION OF EMBODIMENTS

A specific embodiment regarding a graphic meter device of the present invention will be described below with reference to the respective drawings.

### <Specific Example of Display Screen>

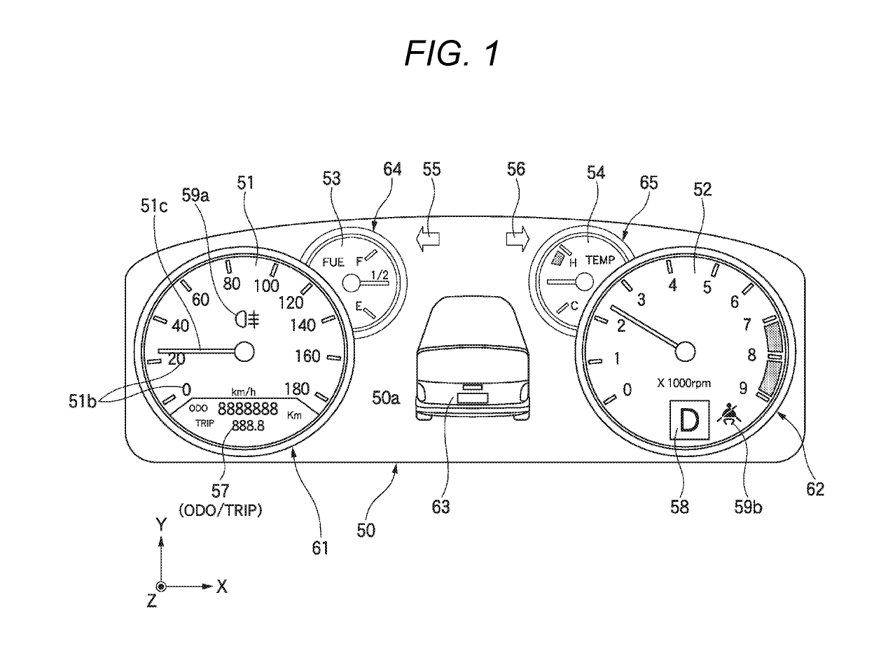

In the present embodiment, a case is assumed in which a vehicular meter unit including a plurality of instruments or indicators is configured as the graphic meter device of the present invention. FIG. 1 illustrates a specific example of an exterior of the entire display screen of the graphic meter device. In addition, a display screen 50 illustrated in FIG. 1 corresponds to the display content on a screen of a liquid crystal display 121 which will be described later. Further, the display content illustrated in FIG. 1 shows a display example in a normal state in which a vehicle can travel.

Instruments such as a speedometer 51, a tachometer 52, a fuel meter 53, a water temperature gauge 54, a turn L display part 55, a turn R display part 56, an odometer 57, a shift indicator 58, and warning display parts 59a and 59b, and decorative images 61 to 65 decorating the instruments are displayed on the display screen 50 illustrated in FIG. 1. In addition, each of the display elements is realized by a graphical display pattern represented by a plurality of sets of display pixels.

Further, in a case where a meter unit 100 has a 3D drawing function, data regarding a three-dimensional model having a stereoscopic configuration is prepared for each instrument in advance, and each instrument may be displayed as a stereoscopic image on the basis of the three-dimensional model. Specifically, a stereoscopic image disposed in a virtual three-dimensional space is generated on the basis of the three-dimensional model through computation, and is drawn in a state in which the generated stereoscopic image is projected onto two-dimensional coordinates of the display screen. Therefore, a screen of the meter unit 100 which actually displays an image is a two-dimensional plane but can draw an image which appears to be stereoscopic.

Still further, an influence of a case where external light coming from a virtual light source disposed at a specific position is incident to a stereoscopic image may be assumed, and shadow, gloss, reflected light, and the like when viewed from a specific viewpoint may be reproduced in the same manner as in a case of a real object and may be reflected in the display content (refer to Patent Literature 1). Consequently, it is possible to obtain a stereoscopic effect similar as in a real object.

The speedometer 51 is a display part displaying a current traveling speed of the vehicle (a vehicle speed: km/h), and, in the present embodiment, is displayed as a circular instrument display part having a pointer and scales in the same manner as a general analog instrument. In addition, the ring-shaped decorative image 61 is displayed so as to surround the periphery of the speedometer 51.

The tachometer 52 is a display part displaying a rotation speed (×1000 rpm) of an engine, and, in the present embodiment, is displayed as a circular instrument display part having a pointer and scales in the same manner as a general analog instrument. In addition, the ring-shaped decorative image 62 is displayed so as to surround the periphery of the tachometer 52.

The fuel meter 53 is a display part displaying a residual fuel quantity of the vehicle, and, in the present embodiment, is displayed as a circular instrument display part having a pointer and scales in the same manner as a general analog instrument. In addition, the ring-shaped decorative image 64 is displayed so as to surround the periphery of the fuel meter 53.

The water temperature gauge 54 is a display part displaying the temperature of cooling water of the vehicle, and, in the present embodiment, is displayed as a circular instrument display part having a pointer and scales in the same manner as a general analog instrument. In addition, the ring-shaped decorative image 65 is displayed so as to surround the periphery of the water temperature gauge 54.

The turn L display part 55 is a leftward facing arrow-shaped pattern, and is displayed in a blinking manner in conjunction with a direction indicating operation when the vehicle is turned to the left. In addition, the turn R display part 56 is a rightward facing arrow-shaped pattern, and is displayed in a blinking manner in conjunction with a direction indicating operation when the vehicle is turned to the right.

The odometer 57 is disposed in an internal region of the speedometer 51, and may display a cumulative traveling distance (ODO) and a section distance (TRIP) of the vehicle as numerical values in the unit of km.

The shift indicator 58 is disposed in an internal region of the tachometer 52, and may display a shift state of a transmission of the vehicle as characters such as P, N, D, 2, and 3.

The warning display parts 59a and 59b are respectively disposed in the internal regions of the speedometer 51 and the tachometer 52. The warning display part 59a may be used to display a warning regarding lighting or the like of lamps. The warning display part 59b may be used to display a warning regarding a seat belt.

The decorative image 63 is a display pattern simulating the entire shape of the vehicle, and is disposed at the center of the screen in the display screen 50 illustrated in FIG. 1. The decorative image 63 may be used to display a current state of the vehicle.

### <Configuration Example of Meter Unit>

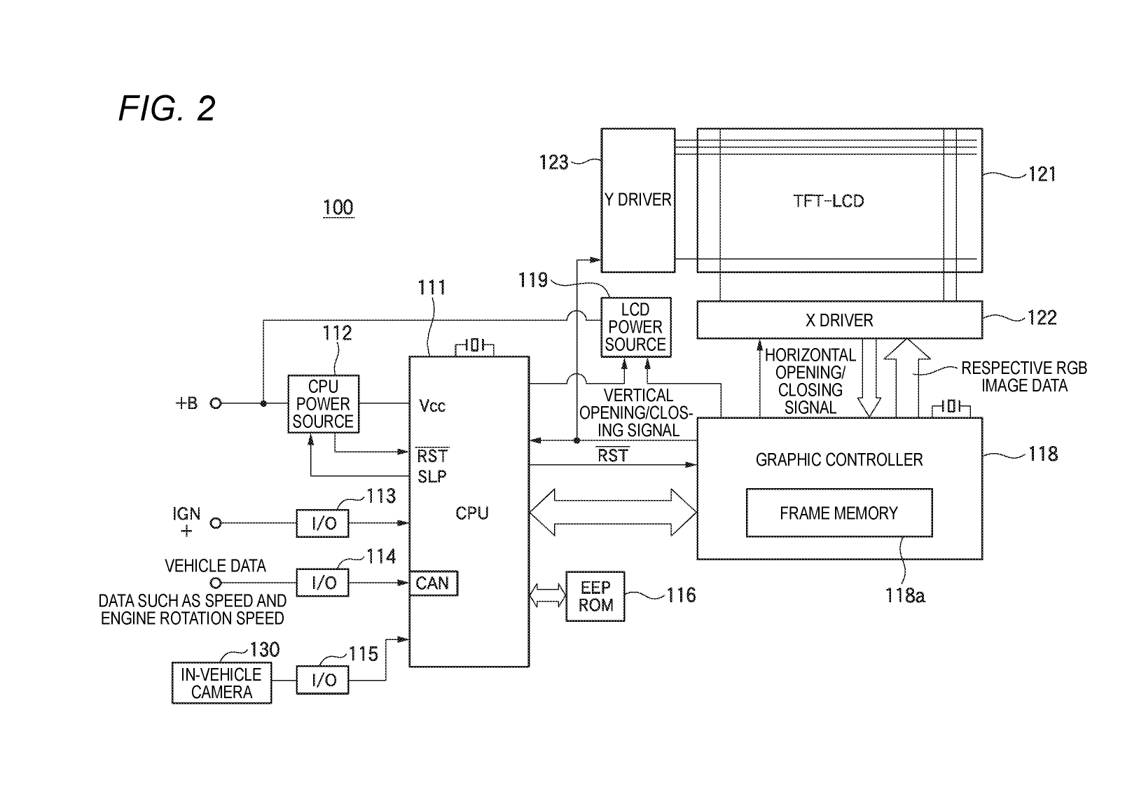

FIG. 2 illustrates a configuration example of an electrical circuit of the meter unit 100 illustrated in FIG. 1.

As illustrated in FIG. 2, the meter unit 100, that is, the graphic meter device includes a microcomputer (CPU) 111, a CPU power source 112, an I/O part 113, an I/O part 114, an interface (I/F) 115, a nonvolatile memory (EEPROM) 116, a graphic controller 118, an LCD power source 119, a liquid crystal display (TFT-LCD) 121, an X driver 122, a Y driver 123, and an in-vehicle camera 130.

The microcomputer 111 executes a control program which is prepared in advance so as to perform processes for realizing various functions required by the meter unit 100. Specifically, data to be displayed is generated by collecting the latest vehicle data including a vehicle speed, the temperature of cooling water, a residual fuel quantity, an engine rotation speed, and the like via the I/O part 114, or by performing necessary computation. In addition, the obtained information is reflected in the display content of each display part on the display screen (50) of the liquid crystal display 121.

The CPU power source 112 receives DC power (+B) supplied from a power source circuit on the vehicle side so as to generate a stable DC voltage (Vcc) which is necessary in operations of circuits such as the microcomputer 111. In addition, the CPU power source 112 may generate a reset signal which is then supplied to the microcomputer 111, or may control a voltage in response to a sleep control signal output from the microcomputer 111.

The I/O part 113 performs signal processing for converting an ignition signal (IGN+) output from the vehicle side into a voltage which can be input to the microcomputer 111.

The I/O part 114 performs signal processing which is required for the microcomputer 111 to be connected to a communication network (controller area network: CAN) on the vehicle. The microcomputer 111 has a communication function corresponding to a CAN standard. Therefore, the microcomputer 111 can perform communication with various electronic control units (ECUs: not illustrated) of the vehicle via the I/O part 114 and the communication network on the vehicle. Through the communication, it is possible to acquire, for example, vehicle data such as a vehicle speed and an engine rotation speed.

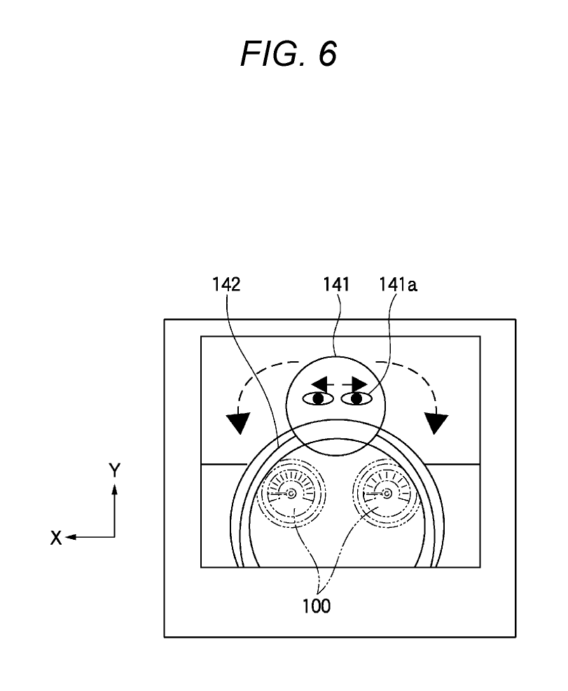

The in-vehicle camera 130 is provided to detect a viewpoint and a visual line of a driver in the present embodiment. Thus, the in-vehicle camera 130 is disposed, for example, on an instrument panel inside the vehicle, and is directed in a direction in which a subject including the entirety of a face 141 of the driver seated on a driver's seat can be imaged. Therefore, for example, an image as illustrated in FIG. 6 may be captured by the in-vehicle camera 130.

The interface 115 processes a video signal output from the in-vehicle camera 130 so as to sequentially generate image data with a predetermined format which can be processed by the microcomputer 111. In addition, in order to reduce a processing load on the microcomputer 111, the interface 115 may have a special processing function such as image recognition.

The nonvolatile memory 116 is constituted of an EEPROM, and is used to hold a variety of fixed data used by the meter unit 100. Specifically, a program executed by the microcomputer 111 or fixed data, such as various constants, is written to the nonvolatile memory 116 in advance.

The liquid crystal display 121 includes the display screen 50 with a two-dimensional array constituted of a plurality of pixels which are arranged in a horizontal (X) direction and a vertical (Y) direction. Each of the plurality of pixels can separately change its intensity (or brightness) or display color under the control of an external device.

The graphic controller 118 controls the content displayed on the display screen 50 of the liquid crystal display 121. The graphic controller 118 has a built-in frame memory 118a which holds data corresponding to the content of all pixels of one frame on the display screen 50. The graphic controller 118 draws data to be displayed on the frame memory 118a, in response to a command output from the microcomputer 111. In addition, the graphic controller 118 outputs a signal (RGB image data) corresponding to each data item on the frame memory 118a to the liquid crystal display 121 in synchronization with timings of a vertical synchronization signal and a horizontal synchronization signal generated therein.

The graphic controller 118 is connected to the liquid crystal display 121 via the X driver 122. The X driver 122 determines a scanning position in the horizontal direction in a pixel group of the liquid crystal display 121 in synchronization with the timing of the horizontal synchronization signal output from the graphic controller 118.

In addition, the Y driver 123 is connected to the liquid crystal display 121 in order to sequentially select respective rows in the Y direction (scan the rows in the Y direction) in the pixel group of the liquid crystal display 121. The Y driver 123 sequentially selects the respective rows in the Y direction in synchronization with the timing of the vertical synchronization signal output from the graphic controller 118.

The LCD power source 119 receives the DC power (+B) supplied from the power source circuit on the vehicle side, and generates a stable voltage which is required to operate the liquid crystal display 121 or a backlight (not illustrated).

### <Operation of Graphic Meter Device>

### <Principle of Detecting Viewpoint Position and Visual Line Direction>

The meter unit 100 operating as the graphic meter device of the present invention requires a function of detecting at least one of a viewpoint position and a visual line direction. Such a function may be realized according to, for example, a principle described below.

### <Detection of Viewpoint Position>

The in-vehicle camera 130 may image a subject including the face 141 of the driver, for example as illustrated in FIG. 6. Therefore, a well-known pattern recognition process is performed on image data obtained through imaging in the in-vehicle camera 130, and thus a pattern having features of the face 141 or the like of the driver can be specified. In addition, left and right eyes 141a may be extracted from a region of the face 141 of the driver, and positions thereof in the X and Y directions may be specified.

Therefore, a position of a viewpoint (eye point) in the X and Y directions may be calculated as, for example, an intermediate position between a position of the left eye and a position of the right eye. In addition, positions of the eyes on the latest image may be tracked by repeatedly processing image data which changes over time, and thus a change in or a movement direction of a position of a viewpoint in the X and Y directions may also be detected.

Further, since an installation position of the in-vehicle camera 130 is fixed, when the driver's face comes close to the screen of the meter unit 100, the size of the face 141 of the driver in a captured image increases. In contrast, when the driver's face goes away from the meter unit 100, the size of the face 141 of the driver in a captured image decreases. Therefore, it is also possible to detect a change in a viewpoint position in a direction (Z direction) perpendicular to the screen of the meter unit 100 by monitoring the size of a specific region such as the face 141 of the driver and identifying a change therein.

### <Detection of Visual Line Direction>

As described above, after the left and right eyes 141a are extracted from the region of the face 141 of the driver, the pupil or the iris located at the center of the eye may be further extracted from a region of each eye. When a person directs a visual line thereof toward the front side, the pupil or the iris is located at the center of the entire eye, but, if the visual line is moved, a position of the pupil or the iris changes in the entire eye. Therefore, a visual line direction can be specified on the basis of a relative positional relationship between the entire region of the eye and a position of the pupil or the iris.

In addition, for example, a position of the nose or the mouth may be detected from the face 141 of the driver, and it may also be identified whether or not the face 141 of the driver is directed toward the front side on the basis of a relative positional relationship between the position and the entire face. Therefore, in a case of identifying whether or not an instrument of the meter unit 100 is located in a visual line direction, determination thereof may be performed on the basis of the face 141 of the driver being directed toward the front side.

### <Content of Major Control>

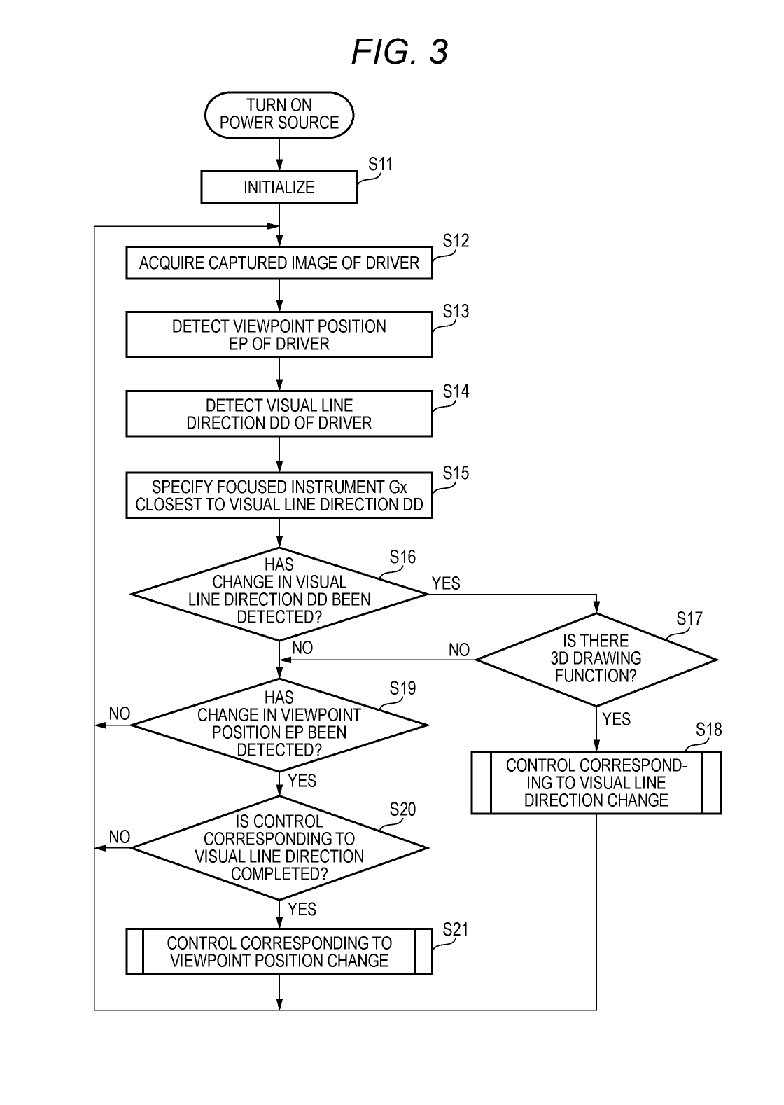

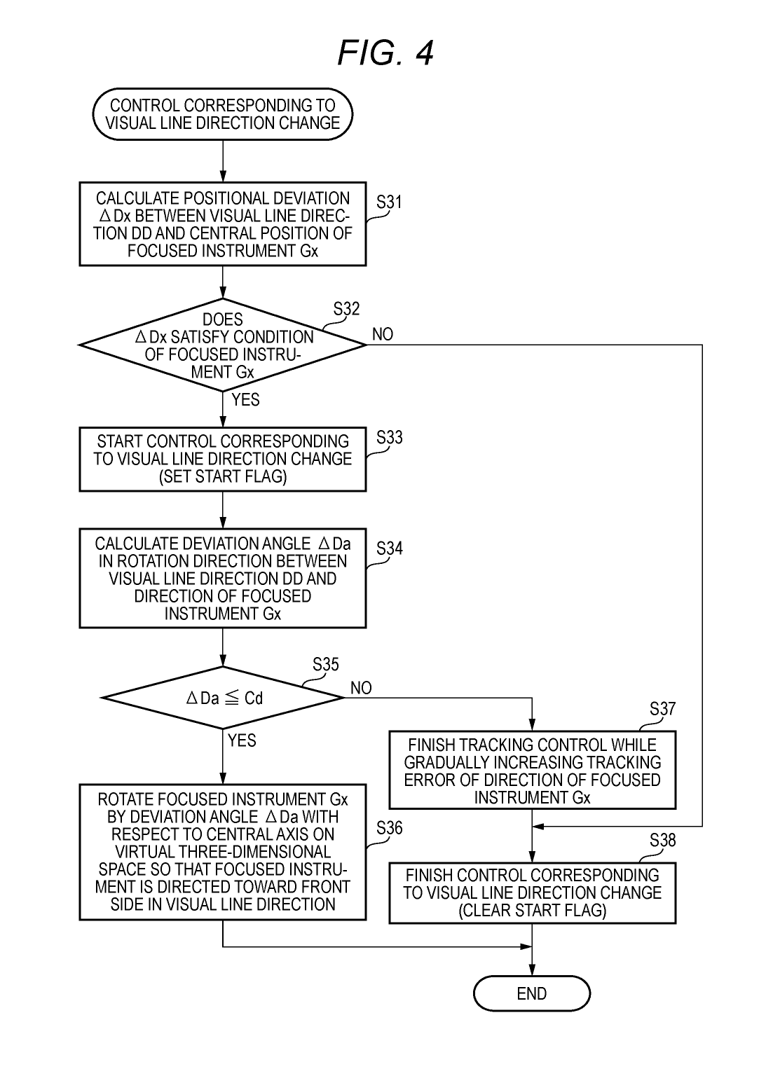

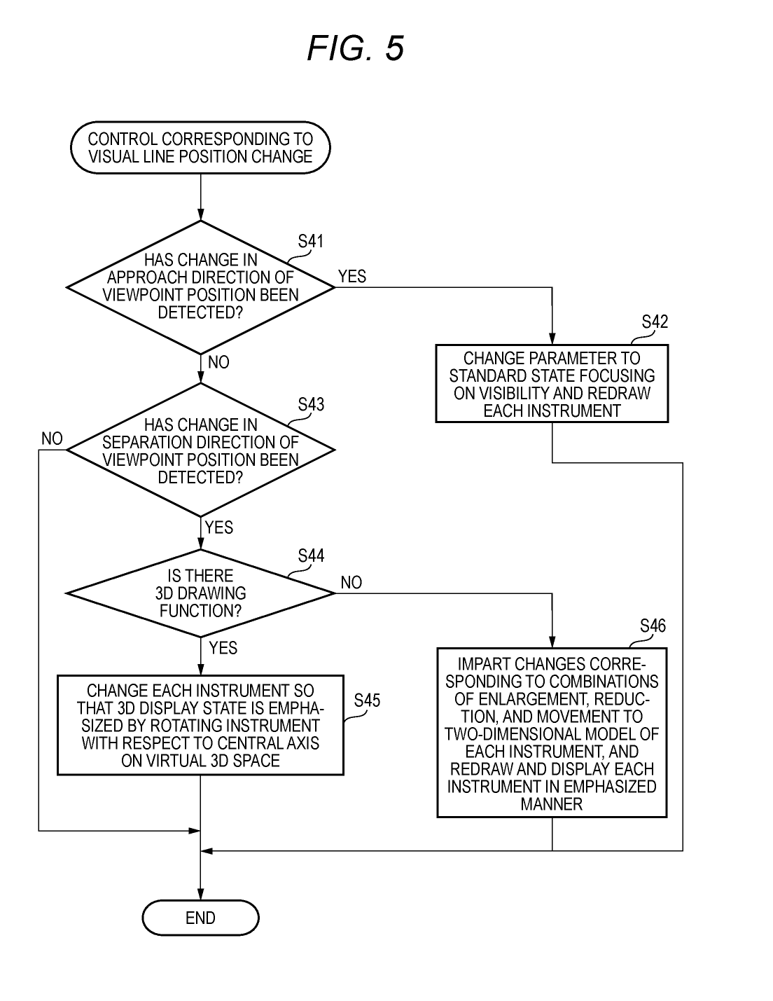

FIG. 3 illustrates the content of major control in the meter unit 100 illustrated in FIG. 1. In addition, FIG. 4 illustrates details of control corresponding to visual line direction change illustrated in FIG. 3, and FIG. 5 illustrates details of control corresponding to viewpoint position change illustrated in FIG. 3.

In other words, the microcomputer 111 illustrated in FIG. 2 performs the control illustrated in FIGS. 3 to 5 so as to impart a special change to a display state of each instrument displayed on the screen of the meter unit 100 in relation to changes in a viewpoint position and a visual line direction of the driver.

If the power source of the meter unit 100 is turned on, the microcomputer 111 performs a predetermined initialization process in step S11. Consequently, the display elements such as the speedometer 51, the tachometer 52, the fuel meter 53, the water temperature gauge 54, and the decorative image 61 to the decorative image 65 illustrated in FIG. 1 are displayed in predefined initial states. Thereafter, the latest vehicle information (a traveling speed, an engine rotation speed, a residual fuel quantity, a cooling water temperature, and the like) which is necessary in display is repeatedly collected through processes (not illustrated), and the information is reflected in a position or the like of a pointer of each instrument.

In step S12, the microcomputer 111 acquires the latest image data obtained through imaging in the in-vehicle camera 130. Consequently, image data with the content as illustrated in FIG. 6 is obtained.

In step S13, the microcomputer 111 detects a viewpoint position EP of the driver by using the image data acquired in step S12. In other words, as described above, the face 141 and the left and right eyes 141a of the driver are recognized, and the viewpoint position EP is calculated on the basis of positions of the left and right eyes 141a. The viewpoint position EP includes coordinates in the X and Y directions and a change (approach/separation) in the Z direction.

In step S14, the microcomputer 111 detects a visual line direction DD of the driver by using the image data acquired in step S12. In other words, as described above, the face 141 and the left and right eyes 141a of the driver are recognized, the pupils or the irises inside the eyes are further recognized, and the visual line direction DD is specified on the basis of a relative positional relationship between the eyes 141a and the pupils or the irises.

In step S15, the microcomputer 111 compares display positions of the various instruments (the speedometer 51, the tachometer 52, the fuel meter 53, the water temperature gauge 54, and the like) displayed on the display screen 50 with the visual line direction DD detected in step S14, and specifies a single instrument located closest to a point at which the visual line direction DD intersects the display screen 50, as a candidate of a focused instrument Gx.

In step S16, the microcomputer 111 identifies whether or not a change of a predetermined level or higher has occurred in the visual line direction DD detected in step S14. The change can be detected by comparing a plurality of processed results in step S14 with each other. In a case where the change in the visual line direction DD is detected, the flow proceeds to step S17, and, in a case where there is no change in the visual line direction DD, the flow proceeds to step S19.

In step S17, the microcomputer 111 identifies whether or not the graphic controller 118 has a predetermined 3D drawing function. In a case where the graphic controller has the 3D drawing function, the flow proceeds to step S18, and, in a case where the graphic controller has only a 2D drawing function, the flow proceeds to step S19. In other words, in the present embodiment, if the 3D drawing function is not installed, “control corresponding to visual line direction change” cannot be accurately performed, and thus the flow proceeds to step S18 only in a case where the 3D drawing function is installed.

In step S18, the microcomputer 111 performs a process for appropriately controlling the display content so as to correspond to a change in a visual line direction. The content illustrated in FIG. 4 corresponds to details of this process. The details will be described later.

In step S19, the microcomputer 111 identifies whether or not a change of a predetermined level or higher has occurred at the viewpoint position EP detected in step S13. The change can be detected by comparing a plurality of processed results in step S13 with each other. In a case where the change in the viewpoint position EP is detected, the flow proceeds to step S20, and, in a case where there is no change in the viewpoint position EP, the flow returns to step S12.

In step S20, the microcomputer 111 identifies whether the control corresponding to visual line direction change is being performed or is completed by referring to a predetermined flag. If the control corresponding to visual line direction change is completed, the flow proceeds to step S21, and, if the control corresponding to visual line direction change is being performed, the flow returns to step S12. In other words, in the present embodiment, of the “control corresponding to visual line direction change” and the “control corresponding to viewpoint position change”, the former is prioritized, and thus a process regarding the latter is not performed while the former is being performed.

In step S21, the microcomputer 111 performs a process for appropriately controlling the display content so as to correspond to a change in a viewpoint position. The content illustrated in FIG. 5 corresponds to details of this process. The details will be described later.

### <Control Corresponding to Visual Line Direction Change>

The content of the “control corresponding to visual line direction change” illustrated in FIG. 4 will be described below.

In step S31, the microcomputer 111 calculates a positional deviation (distance) ΔDx between a point on the display screen 50 intersected by the current visual line direction DD and a central position of the current focused instrument Gx.

In step S32, the microcomputer 111 identifies whether or not the positional deviation ΔDx satisfies the condition of the focused instrument Gx by comparing the positional deviation ΔDx calculated in step S31 with a predefined threshold value (an upper limit value of the distance). In a case where the positional deviation ΔDx satisfies the condition of the focused instrument Gx, the flow proceeds to step S33, and in a case where the condition is not satisfied, the flow proceeds to step S38.

In step S33, the microcomputer 111 sets a predetermined start flag in order to clearly show that the “control corresponding to visual line direction change” is being performed. In addition, in a case where the start flag has already been set, the current state is maintained.

In step S34, the microcomputer 111 calculates a deviation angle ΔDa in a rotation direction between the current visual line direction DD and the current direction of the focused instrument Gx.

In a case of using the 3D drawing function, an image of each instrument drawn on the display screen 50 is managed as a stereoscopic image which is disposed in a virtual three-dimensional space on the basis of data regarding a predefined three-dimensional model, and a result of the stereoscopic image being projected onto two-dimensional coordinates is actually displayed on the display screen 50. Thus, the stereoscopic image of each instrument can be freely rotated or moved on the three-dimensional space. In step S34, a reference direction is set in a state in which a direction perpendicular to a surface (front surface) of the focused instrument Gx matches the visual line direction DD, and an error between the current rotation direction of the stereoscopic image of the focused instrument Gx and the reference direction is calculated as the deviation angle ΔDa. For example, in a state in which the deviation angle ΔDa is 0, the focused instrument Gx is disposed on the three-dimensional space as a stereoscopic image in a state of being directed toward the front side of the driver.

In step S35, the microcomputer 111 compares the deviation angle ΔDa in the rotation direction calculated in step S34 with a predefined angle threshold value Cd. If a condition of “ΔDa≦Cd” is satisfied, the flow proceeds to step S36, and if the condition is not satisfied, the flow proceeds to step S37.

In addition, the angle threshold value Cd may be controlled to be changed depending on a situation. For example, a relatively great value is allocated to the angle threshold value Cd only right after the start flag is set, and the angle threshold value Cd may be switched to a small value after control for tracking a rotation direction is started.

In step S36, the microcomputer 111 rotates the stereoscopic image corresponding to the focused instrument Gx by the deviation angle ΔDa with respect to a central axis of the instrument on the virtual three-dimensional space. In other words, the image of the focused instrument Gx is rotated in the direction in which the deviation angle ΔDa becomes 0 at its location in a state in which a position thereof is fixed. Consequently, a state of the focused instrument Gx changes to a state of being directed toward the front side in the visual line direction.

In step S37, the microcomputer 111 rotates the direction of the image of the focused instrument Gx as in step S36. However, a rotation amount thereof is made smaller than the deviation angle ΔDa, and thus a tracking error is intentionally generated. In addition, the tracking error is gradually increased, and then the tracking control is finished over time.

In step S38, the microcomputer 111 finishes the execution of the “control corresponding to visual line direction change”, and clears the start flag in order to clearly show that the operation is finished. For example, in a case where the driver intentionally deviates a visual line thereof relative to the focused instrument Gx which is watched until then, the control illustrated in FIG. 4 on the focused instrument Gx is finished, and the state is clearly shown by clearing the start flag.

In addition, in the control illustrated in FIG. 4, in relation to the focused instrument Gx located in the visual line direction DD, the stereoscopic instrument is directed in the direction perpendicular to the visual line direction, but may be changed so as to be directed toward the front side of the display screen 50.

### <Control Corresponding to Viewpoint Position Change>

The content of the “control corresponding to viewpoint position change” illustrated in FIG. 5 will be described below.

In step S41, the microcomputer 111 monitors a temporal change in the viewpoint position EP in the Z direction or the X and Y directions for each instrument, and identifies whether or not a change in an approach direction has been detected. In a case where the change in the approach direction has been detected, the flow proceeds to step S42, and, in a case where the change has not been detected, the flow proceeds to step S43.

In step S42, the microcomputer 111 changes various parameters used to draw a corresponding instrument on the display screen 50 to a standard state focusing on visibility, and redraws each instrument on the screen. In addition, the parameters in the standard state may employ constants such as initial values which are determined in advance by a manufacturer, and may employ constants which are adjusted in advance according to a user's preference.

Regarding the content of specific control in step S42, in a case where an instrument is stereoscopically drawn by using the 3D drawing function, it is expected that an inclination is made 0 by matching a direction of the stereoscopic instrument with a direction of the display screen 50 or display elements such as shadow, gloss, and reflected light are returned to initial states in which the influence of external light is relatively slight, thereby improving visibility. In addition, in a case where the 3D drawing function cannot be used, it is expected that the size of a displayed instrument, a display position, a font of a character, a display color, and the like are fixed in states in which visibility is highest.

In step S43, the microcomputer 111 monitors a temporal change in the viewpoint position EP in the Z direction or the X and Y directions for each instrument, and identifies whether or not a change in a separation direction has been detected. In a case where the change in the separation direction has been detected, the flow proceeds to step S44, and, in a case where the change has not been detected, the process ends.

In step S44, the microcomputer 111 identifies whether or not the graphic controller 118 has a predetermined 3D drawing function. In a case where the graphic controller has the 3D drawing function, the flow proceeds to step S45, and, in a case where the graphic controller has only a 2D drawing function, the flow proceeds to step S46.

In step S45, the microcomputer 111 rotates a corresponding instrument with respect to a central axis of the instrument on the virtual three-dimensional space in a state in which a position thereof is fixed. If the stereoscopic instrument is rotated at its location, a change occurs so that a different part is displayed due to the rotation. In addition, shadow, gloss, reflected light, and the like on the instrument are also changed due to the rotation. Therefore, it is possible to impart a change so that a stereoscopic display state is temporarily emphasized.

In step S46, the microcomputer 111 simultaneously imparts a plurality of kinds of changes such as enlargement, reduction, and movement to a two-dimensional model of each instrument, or imparts the changes in turn by delaying time, thereby displaying the instrument in a temporarily emphasized state. In other words, a display state is changed so that an emphasis effect similar as in a case where a stereoscopic instrument is displayed is achieved by performing the changes such as enlargement, reduction, and movement in a combining manner.

In addition, the process illustrated in FIG. 5 may be separately performed on each instrument displayed on the display screen 50. Thus, in a case where a plurality of instruments are simultaneously displayed on the display screen 50 as illustrated in FIG. 1, a process (step S42) corresponding to a case of approach of a viewpoint position may be performed on a certain instrument, and processes (steps S45 and S46) corresponding to a case of separation of a viewpoint position may be performed on other instruments.

### <Description of Operation Example>

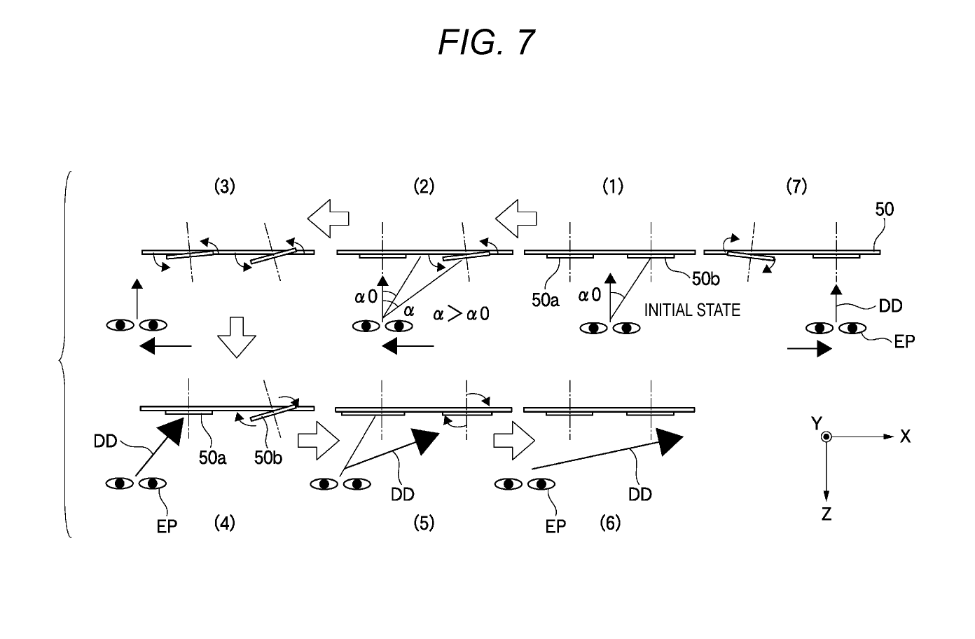

FIG. 7 is a schematic diagram illustrating summary of a case where the display screen 50 of the meter unit 100 is viewed from the top, and illustrates a specific example of display content state transition corresponding to changes in a viewpoint and a visual line. In other words, by performing the controls illustrated in FIGS. 3 to 5, each of instruments 50a and 50b displayed on the display screen 50 can be changed depending on a change in a viewpoint position or a visual line direction as in states (1), (2), (3), (4), (5), (6), and (7) in FIG. 7.

In an initial state indicated as the state (1) in FIG. 7, a case is assumed in which the viewpoint position EP is present at a location opposing a position which is located substantially in the middle of the two instruments 50a and 50b on the display screen 50. If the driver moves the head thereof so that the viewpoint position EP is moved to the left, the initial state transitions to the state (2). Conversely, the viewpoint position EP is moved to the right, the initial state transitions to the state (3). The state (2) may transition to each of the states (3), (4), (5), and (6).

In a case where the state (1) transitions to the state (2) in FIG. 7, the microcomputer 111 detects a situation in which the viewpoint position EP go away from the right instrument 50b. Thus, in the state (2) in FIG. 7, the attitude of the stereoscopically displayed instrument 50b is changed so that the instrument is rotated at its location. In the example illustrated in FIG. 7, since the instrument 50b is rotated in the clockwise direction in a state of being viewed from the top, a direction of the instrument 50b is changed so as to become further distant from the viewpoint position EP, and thus a stereoscopic effect is emphasized.

In contrast, in a case where the state (1) transitions to the state (7) in FIG. 7, the microcomputer 111 detects a situation in which the viewpoint position EP go away from the left instrument 50a. Thus, in the state (7) in FIG. 7, the attitude of the stereoscopically displayed instrument 50a is changed so that the instrument is rotated at its location. In the example illustrated in FIG. 7, since the instrument 50a is rotated in the counterclockwise direction in a state of being viewed from the top, a direction of the instrument 50a is changed so as to go further away from the viewpoint position EP, and thus a stereoscopic effect is emphasized.

In a case where the state (1) successively transitions to states (2) and (3) in FIG. 7, the viewpoint position EP changes so as to approach (transition from the state (1) to the state (2)), to pass (transition from the state (2) to the state (3)), and to go further away from the left instrument 50a in terms of a relative positional relationship.

In addition, as in the state (3) in FIG. 7, a direction of the instrument 50a is changed so that the stereoscopic image thereof is rotated at its location in the direction of becoming further distance relative to the movement direction of the viewpoint position EP from the time at which the viewpoint position EP passes the left instrument 50a.

In addition, in a case where the passing viewpoint position EP is moved in a direction of approaching the instrument 50b again as in the state (4) in FIG. 7, the direction of the stereoscopic image of the instrument 50b is returned to the direction (for example, the initial state: a state in which the instrument is directed toward the front side) in the reference state, and then the instrument is redrawn (refer to step S42 in FIG. 5).

Further, in a case where a visual line is moved from a state in which the visual line direction DD matches the left instrument 50a on the display screen 50 as in the state (4) in FIG. 7 to a state in which the visual line direction DD matches the right instrument 5b as in the state (5), the stereoscopic image of the right instrument 5b is rotated at its location as in the state (5), and thus the instrument 5b is directed in the direction perpendicular to the visual line direction DD or toward the front side of the display screen 50. Consequently, it is possible to improve the visibility of an instrument watched by the driver.

Still further, the left instrument 50a which the visual line direction DD has passed (which is not watched) as in the state (5) in FIG. 7, or the right instrument 50b which the visual line direction DD has passed as in the state (6) in FIG. 7 is maintained in its state while being directed toward the front side.

In addition, as illustrated in FIG. 7, both of the control on the viewpoint position EP and the control on the visual line direction DD are performed, but the control on the visual line direction DD is preferentially performed in the controls illustrated in FIGS. 3 to 5. Therefore, a focused instrument can be directed toward the front side relative to a visual line direction at all times.

### APPENDIXES

Here, the features of the embodiment of the graphic meter device according to the present invention are listed in the following [1] to [6] in a concise manner.

[1] A graphic meter device (meter unit 100) in which at least one instrument (51, 52, 53, 54, and the like) is drawn on a display screen (50), the device comprising:

a user detection part (in-vehicle camera 130) which detects one or both of a position of a viewpoint and a direction of a visual line in which the display screen is visually recognized; and

a display control part (microcomputer 111) which controls a display state by changing the instrument drawn on the display screen corresponding to changes in the one or both of the position of the viewpoint and the direction of the visual line detected by the user detection part.

[2] The graphic meter device according to [1],

wherein the display control part controls the display state by changing the instrument drawn on the display screen in one aspect or a plurality of aspects out of enlargement, reduction, and movement, which are combined.

[3] The graphic meter device according to [1],

wherein the display control part controls the display state by changing the instrument drawn on the display screen in an aspect of rotation around a predetermined axis.

[4] The graphic meter device according to [1],

wherein, in a case where the display control part recognizes a situation in which one of the instruments is located in the direction of the visual line detected by the user detection part, the display control part rotates the instrument so as to be a positional relationship in which the front side of the instrument is perpendicular to the direction of the visual line.

[5] The graphic meter device according to any one of [1] to [4],

wherein, in a case where the display control part recognizes a situation in which the viewpoint detected by the user detection part comes close to the display screen, the display control part controls the display state by changing the instrument drawn on the display screen.

[6] The graphic meter device according to any one of [1] to [4],

wherein, in a case where the display control part recognizes a situation in which the viewpoint detected by the user detection part goes away from the display screen, the display control part controls the display state by changing the instrument drawn on the display screen.

The present invention has been described in detail with reference to the specific embodiment, but it is clear to a person skilled in the art that various modifications or alterations may occur without departing from the spirit and the scope of the present invention.

This application is based upon and claims the benefit of priority from Japanese Patent Application No. 2013-249251, filed Dec. 2, 2013; the entire contents of which are incorporated herein by reference.

### INDUSTRIAL APPLICABILITY

According to the present invention, since special performance can be performed by automatically changing display content when a user's attitude or the like is changed, an effect is achieved in which it is possible to visually provide a performance effect to the user. The present invention achieving the effect is useful for a graphic meter device which can perform graphical display.

### REFERENCE SIGNS LIST

50 DISPLAY SCREEN
51 SPEEDOMETER
52 TACHOMETER
53 FUEL METER
54 WATER TEMPERATURE GAUGE
55 TURN L DISPLAY PART
56 TURN R DISPLAY PART
57 ODOMETER
58 SHIFT INDICATOR
59a AND 59b WARNING DISPLAY PART
61, 62, 63, 64, AND 65 DECORATIVE IMAGE
100 METER UNIT
111 MICROCOMPUTER
112 CPU POWER SOURCE
113 AND 114 I/O PART
115 INTERFACE
116 NONVOLATILE MEMORY
118 GRAPHIC CONTROLLER
118a FRAME MEMORY
119 LCD POWER SOURCE
121 LIQUID CRYSTAL DISPLAY
122 X DRIVER
123 Y DRIVER
130 IN-VEHICLE CAMERA
141 FACE OF DRIVER
141a EYE
142 STEERING WHEEL

What is claimed is:

1. A graphic meter device in which at least one instrument is drawn on a display screen, the device comprising:
a user detection part which detects one or both of a position of a viewpoint and a direction of a visual line in which the display screen is visually recognized; and
a display control part which controls a display state by changing the instrument drawn on the display screen corresponding to changes in the one or both of the position of the viewpoint and the direction of the visual line detected by the user detection part.

2. The graphic meter device according to claim 1,
wherein the display control part controls the display state by changing the instrument drawn on the display screen in one aspect or a plurality of aspects out of enlargement, reduction, and movement, which are combined.

3. The graphic meter device according to claim 1,
wherein the display control part controls the display state by changing the instrument drawn on the display screen in an aspect of rotation around a predetermined axis.

4. The graphic meter device according to claim 1,
wherein, in a case where the display control part recognizes a situation in which one of the instruments is located in the direction of the visual line detected by the user detection part, the display control part rotates the instrument so as to be a positional relationship in which the front side of the instrument is perpendicular to the direction of the visual line.
